(19) United States
(12) Patent Application Publication
(10) Pub. No.: US 2007/0069621 A1
(43) Pub. Date: Mar. 29, 2007

(54) METHOD FOR FABRICATING FIELD EMISSION LUMINESCENT DEVICE

(75) Inventors: Lin-En Chou, Hsinchu (TW); Wei-Yi Lin, Hsinchu (TW); Bing-Nan Lin, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Industrial Technology Research Institute, Hsinchu (TW)

(21) Appl. No.: 11/530,265

(22) Filed: Sep. 8, 2006

(30) Foreign Application Priority Data
Sep. 23, 2005 (TW) 094133234

(51) Int. Cl. H01J 1/02

(52) U.S. Cl. 313/309

(57) ABSTRACT

A method for fabricating an anode plate of field emission luminescent device is provided. The method includes the steps of forming a metal layer on a substrate by using the physical or chemical deposition, printing a pattered protection layer on the metal layer, and sintering the pattered protection layer and oxidizing a potion of the metal layer, which is not covered by the pattered protection layer, so as to form a pattered electrode on the metal layer.

### FIELD OF THE INVENTION

The present invention relates to a method for fabricating a luminescent device, and in particular to a method for fabricating an electrode plate for the field emission luminescent device.

### BACKGROUND OF THE INVENTION

It is well known that the field emission luminescent device is one of the promising flat luminescent device that could be widely used for the flat panel display, since it has the advantages of the simpler structure, the lower driving voltage, and the higher brightness. Typically, the field emission luminescent device includes mainly an anode and a cathode plates, and an electron beam generated from the cathode electrode plate is drawn by the anode plate for ramming into a fluorescence layer, so that an emitted light in response to a collision of the electron beam to the fluorescence layer is generated.

Please refer to FIGS. 1(A) and 1(B), which respectively shows a transmission type field emission luminescent device and a reflection type field emission luminescent device according to the prior art. As shown in FIG. 1(A), the field emission luminescent device 100 includes an anode plate 10 and a cathode plate 20. The anode plate 10 further includes a substrate 12 having thereon an anode electrode layer 14 and a fluorescence layer 16, while the cathode plate 20 further includes a further substrate 22 having thereon a cathode electrode layer 24 facing to the anode plate 10. The anode electrode layer 14 and the cathode electrode layer 24 are respectively applied with a positive and a negative voltage, so that an electron beam 30 generated from the cathode electrode layer 24 is drawn by the anode electrode layer 14 and rams into the fluorescence layer 16. Therefore, an emitted light is generated in response to a collision of the electron beam 30 to the fluorescence layer 16 and transmitted through the anode plate 10 for luminescence.

However, since the light generated in the fluorescence layer 16 is emitted non-directionally, only the transmission parts of the emitted light could contribute to the luminescence brightness of the field emission luminescent device, while the other parts of the emitted light have no contribution to the luminescence brightness of the field emission luminescent device. Accordingly, a reflection type field emission luminescent device 200 as shown in FIG. 1(B) is improved to enhance the brightness of the field emission luminescent device. Comparing with the transmission type field emission luminescent device 100, the reflection type field emission luminescent device 200 has almost the identical structure except a reflection layer 18 being arranged on the opposite side of the anode substrate 12. With such a structural design, the emitted light transmitted through the anode substrate 12 will be reflected by the reflection layer 18, and most of the emitted light 50 will be transmitted through the cathode substrate 22, so that the luminescence brightness of the field emission luminescent device could be remarkably enhanced.

However, no matter it is the transmission type field emission luminescent device or the reflection type field emission luminescent device, the anode or the cathode electrode in the respective electrode layer should be well patterned, in order to precisely control the collision positions of the electron beam in the fluorescence layer. Therefore, it is necessary to pattern the anode and/or the cathode electrodes when fabricating the electrode plate for the field emission luminescent device.

Please refer to FIG. 2, which shows a fabricating process for an anode plate of the field emission luminescent device according to the prior art. As shown in FIG. 2, a substrate 12 is firstly provided. Next, a patterned anode electrode layer 14 is formed on the substrate 12. Since the anode electrode layer 14 is patterned, a patterned process should be performed in the formation process of the anode electrode layer 14. Furthermore, the sequential step of forming a fluorescence layer 16 on the anode electrode layer 12 will also include a patterned process since the fluorescence layer 16 and the anode electrode layer 14 should have the corresponding patterns. Finally, sintering the fluorescence layer 16 and the fabrication process of the anode plate for the field emission luminescent device is finished. Generally, the patterned process of the anode electrode layer 14 is performed by a semiconductor process or a printing process. However, the semiconductor process is expensive, while the printing process costs time for drying. Furthermore, the sequential step of forming a fluorescence layer 16 on the patterned electrode layer also costs time and resources for the high temperature sintering. Therefore, the conventional fabricating process for the electrode plate of the field emission luminescent device might be time-consuming and complicated. Accordingly, it might be necessary to provide an improved method for fabricating an electrode plate for the field emission luminescent device.

### SUMMARY OF THE INVENTION

It is a first aspect of the present invention to provide an improved method for fabricating a field emission luminescent device. The method includes the step of providing a substrate, forming a metal layer on the substrate, printing a fluorescent layer on the metal layer, and sintering the fluorescent layer and oxidize the metal layer at the same time.

Preferably, the step of forming the metal layer is processed by a silver mirror reaction (AgNO₃+NaOH+NH₃+C₆H₁₂O₆).

Preferably, the step of forming the metal layer is processed by an electroless plating.

Preferably, the metal layer is formed by one selected from a group consisting of silver, aluminum and copper.

Preferably, the fluorescent layer printed on the metal layer has a predetermined pattern, so that the metal layer exposes portions not covered by the fluorescent layer.

Preferably, the exposed portions are oxidized when the pattered fluorescent layer is sintered.

Preferably, the step of oxidizing the metal layer is processed by one selected from a group consisting of a burning oxidation process, a plasma oxidation process and a chemical catalyst oxidation process.

Preferably, the protection layer is a fluorescent layer on an anode plate of the field emission luminescent device.

Preferably, the protection layer is an emitter layer on an cathode plate of the field emission luminescent device.

It is a second aspect of the present invention to provide a method for fabricating a field emission luminescent device. The method includes the steps of providing a substrate, forming a conducting layer on the substrate, defining a conducting portion and an insulating portion on the conducting layer by forming a patterned protection layer on the conducting portion of the conducting layer; and sintering patterned protection layer and oxidizing the insulating portion of the conducting layer at the same time.

It is a third aspect of the present invention to provide An electrode plate for a field emission luminescent device. The electrode plate includes a substrate, an electrode layer formed on the substrate and having a metal portion and a metal oxide portion, and an oxidation resistant layer formed on the electrode layer.

Preferably, the oxidation resistant layer has a predetermined pattern and the metal portion are exactly covered by the pattered oxidation resistant layer.

Preferably, the oxidation resistant layer is a protecting layer for the metal portion.

Preferably, the oxidation resistant layer is one of a fluorescent layer and an emitter layer.

Preferably, the metal portion is a conducting electrode portion of the electrode plate and the metal oxide portion is an insulating portion of the electrode plate.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIGS. 1(A) and 1(B) respectively shows a transmission type field emission luminescent device and a reflection type field emission luminescent device according to the prior art;

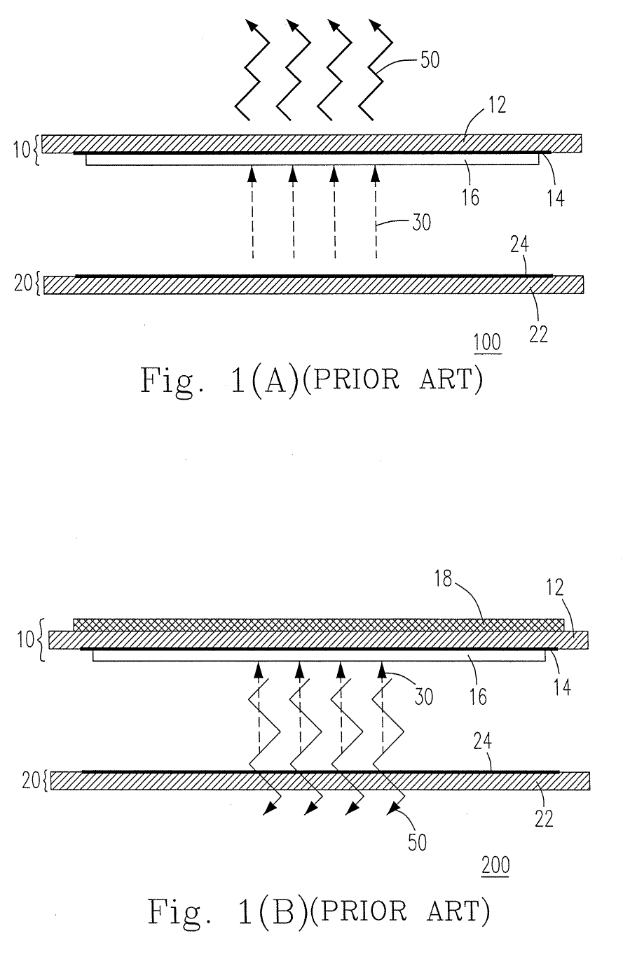

FIG. 2 shows a conventional fabricating process for an anode plate of the field emission luminescent device; and

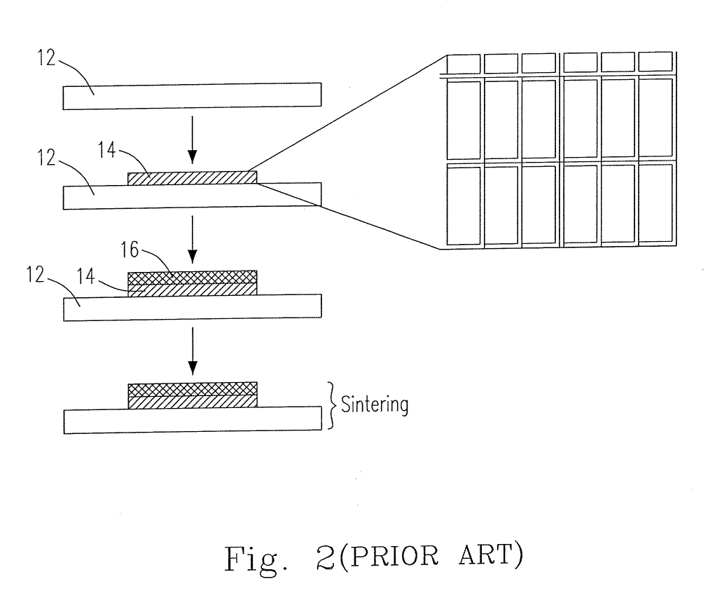

FIG. 3 shows a fabricating process for an anode plate of the field emission luminescent device according a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; it is not intended to be exhaustive or to be limited to the precise form disclosed.

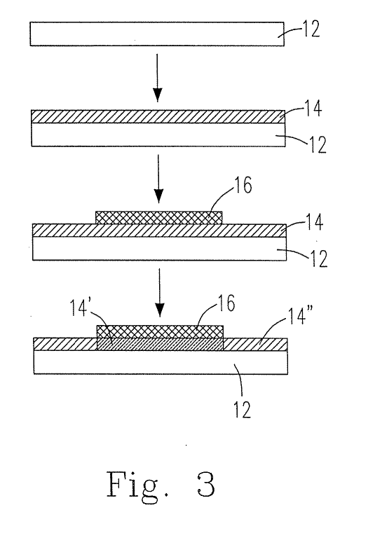

Please refer to FIG. 3, which shows a fabricating process for an anode plate of the field emission luminescent device according a preferred embodiment of the present invention. As shown in FIG. 3, the fabricating process including the step of providing a substrate 12 for the anode plate. The substrate 12 is previous to light and has the ability of the electrical conduction. Preferably, the substrate 12 is an transparent glass substrate. In the next step, a metal layer is formed on the substrate 12 through a physical or chemical deposition process, such as a silver mirror reaction (AgNO₃+NaOH+NH₃+C₆H₁₂O₆) or an electroless plating. The so called silver mirror reaction is carried out by Tollen's reagent reacting with the glucose solution, so that the silver metal contained in the Tollen's reagent is precipitated therefrom. In addition to the silver mirror reaction, the metal layer 14 of the anode plate might be formed by the electroless plating bath, and the metal can be further chosen from silver, aluminum or copper.

It should be noted that the patterned process of the metal layer 14 is excluded from the formation process of the metal layer 14, so that the cheaper and easier deposition process, such as the silver mirror reaction or the electroless plating can be preformed in the fabricating process of the anode plate for the field emission luminescent device.

After the metal layer 14 is formed on the substrate 12, a fluorescence layer 16 having a predetermined pattern is formed on the metal layer through a printing process, such as an inject printing or a screen printing process. Since the fluorescence layer 16 has a predetermined pattern, the metal layer 14 can thus be divided into an exposed portion 14″ not covered by the patterned fluorescence layer 16 and a protected portion 14′ covered by the patterned fluorescence layer 16, as shown in FIG. 3. After the patterned fluorescence layer 16 is formed on the metal layer 14, the fluorescence layer 16 should be further processed at around 480 ° C. for a sintering treatment. In a preferred embodiment, the sintering treatment is carried out at a burned gas atmosphere consisting of nitrogen and oxygen at a ratio about 4:1. During the sintering process, the exposed portion 14″ of the metal layer 14 not covered by the patterned fluorescence layer 16 will be oxidized, so that the exposed portion 14″ will be transformed into the metal oxide for serving as the insulating portion of an electrode layer formed by the metal layer 14. On the other hand, the protected portion 14′ of the metal layer 14 will remain as the metal form during the sintering process since the patterned fluorescence layer 16 serves as an protection layer or an oxidation resistant layer to prevent the protected portion 14′ from being oxidized. Accordingly, the protected portion 14′ retaining the electrical conducting ability can be acted as the conducting electrode potion of the electrode layer. Therefore, with the sintering process, the metal layer 14 is further patterned by forming a patterned protection layer (or the fluorescence layer 16) on the protected portion (or the conducting electrode portion) 14′ of the metal layer 14, and the fluorescence layer 16 and the conducting electrode 14′ can easily have the corresponding pattern without any additional patterned process.

On the other hand, it is also worthy to note that a fabricating process for an cathode plate of the filed emission luminescent device is capable of being explained though the illustration of FIG. 3. The detailed steps for fabricating the cathode plate of the filed emission luminescent device are described as follows. First, a substrate 12 is provided for the cathode plate. The substrate 12 is also previous to light and has the ability of the electrical conduction, and preferably, the substrate 12 can be an transparent glass substrate. In the next step, a metal layer 14 is formed on the substrate 12 through a physical or chemical deposition process, such as a silver mirror reaction (AgNO₃+NaOH+NH₃+C₆H₁₂O₆) or an electroless plating, in which no complicated patterned process of the metal layer 14 is implemented during the deposition in order to simplify the deposition process. The so called silver mirror reaction is carried out by Tollen's reagent reacting with the glucose solution, so that the silver metal contained in the Tollen's reagent is precipitated therefrom. In addition to the silver mirror reaction, the metal layer 14 of the cathode plate also can be formed by the electroless plating bath, and the metal can be further chosen from silver, aluminum or copper. Finally, after the metal layer 14 is formed on the substrate 12, a emitter layer having a predetermined pattern, in stead of the fluorescence layer 16 having a predetermined pattern, is formed on the metal layer through a printing process, such as an inject printing or a screen printing process. Similarly, since the emitter layer also formed through a predetermined pattern, the metal layer 14 can thus be divided into an exposed portion 14″ not covered by the patterned emitter layer and a protected portion 14′ covered thereby, as shown in FIG. 3. Accordingly, after the sintering treatment of the cathode plate, the exposed portion 14″ of the metal layer 14 not covered by the patterned emitter layer will be oxidized, so that the exposed portion 14″ will be transformed into the metal oxide for serving as the insulating portion of an electrode layer formed by the metal layer 14, while the protected portion 14′ of the metal layer 14 will remain as the metal during the sintering process since the patterned emitter layer 16 serves as an protection layer or an oxidation resistant layer to prevent the protected portion 14′ from being oxidized. Therefore, with such a process, the metal layer 14 in the respective the anode and cathode plates is further patterned by forming a patterned protection layer (the patterned emitter layer or the patterned fluorescence layer 16) on the protected portion (or the conducting electrode portion) 14′ of the metal layer 14, and the patterned protection layer and the protected portion 14′ of the metal layer 14 can easily have the corresponding pattern without taking any further patterned process.

In a preferred embodiment of the present invention, the abovementioned sintering treatment can be alternatively replaced by or incorporated with a burning oxidation process, a plasma oxidation process, or a chemical catalyst oxidation process. It is worthy to noted that the fabricating process provided in the present invention for the anode plate of the field emission luminescent device is almost carried out by the faster, easier and inexpensive process, so that the fabrication cost for anode plate of the field emission luminescent device can be remarkably reduced. However, the above mentioned process should be performed cooperatively, so that the advantage of the fabrication method of the present invention can be achieved.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for fabricating a field emission luminescent device, comprising step of:
providing a substrate;
forming a metal layer on the substrate;
printing a protection layer on the metal layer; and
sintering the protection layer and oxidize the metal layer at the same time.

2. The method according to claim 1, wherein the step of forming the metal layer is processed by a silver mirror reaction (AgNO₃+NaOH+NH₃+C₆H₁₂O₆).

3. The method according to claim 1, wherein the step of forming the metal layer is processed by an electroless plating.

4. The method according to claim 3, wherein the metal layer is formed by one selected from a group consisting of silver, aluminum and copper.

5. The method according to claim 1, wherein the protection layer printed on the metal layer has a predetermined pattern, so that the metal layer exposes portions not covered by the protection layer.

6. The method according to claim 5, wherein the exposed portions are oxidized when the pattered protection layer is sintered.

7. The method according to claim 1, wherein the protection layer is a fluorescent layer on an anode plate of the field emission luminescent device.

8. The method according to claim 1, wherein the protection layer is an emitter layer on an cathode plate of the field emission luminescent device.

9. The method according to claim 1, wherein the step of oxidizing the metal layer is processed by one selected from a group consisting of a burning oxidation process, a plasma oxidation process and a chemical catalyst oxidation process.

10. A method for fabricating a field emission luminescent device, comprising the steps of:
providing a substrate;
forming a conducting layer on the substrate;
defining a conducting portion and an insulating portion on the conducting layer by forming a patterned protection layer on the conducting portion of the conducting layer; and
sintering patterned protection layer and oxidizing the insulating portion of the conducting layer at the same time.

11. An electrode plate for a field emission luminescent device, comprising
a substrate;
an electrode layer formed on the substrate and having a metal portion and a metal oxide portion; and
an oxidation resistant layer formed on the electrode layer,
wherein the oxidation resistant layer has a predetermined pattern and the metal portion are exactly covered by the pattered oxidation resistant layer.

12. The electrode plate according to claim 11, wherein the oxidation resistant layer is a protection layer for the metal portion.

13. The electrode plate according to claim 11, wherein the oxidation resistant layer is one of a fluorescent layer and an emitter layer.

14. The electrode plate according to claim 11, wherein the metal portion is a conducting electrode portion of the electrode plate and the metal oxide portion is an insulating portion of the electrode plate.
